(19) United States
(12) Patent Application Publication
(10) Pub. No.: US 2026/0142761 A1
(43) Pub. Date: May 21, 2026

(54) METHOD, APPARATUS AND SYSTEM FOR DATA TRANSMISSION

(71) Applicant: Huawei Technologies Co., Ltd., Shenzhen (CN)

(72) Inventors: Huazi Zhang, Zhejiang (CN); Xiaoyan Bi, Shanghai (CN); Jianglei Ma, Ottawa (CA); Wen Tong, Ottawa (CA)

(21) Appl. No.: 19/445,242

(22) Filed: Jan. 9, 2026

Related U.S. Application Data
(63) Continuation of application No. PCT/CN2024/090923, filed on Apr. 30, 2024.
(60) Provisional application No. 63/526,073, filed on Jul. 11, 2023.

(51) Int. Cl. H04L 5/00; H04W 72/044

(52) U.S. Cl. CPC H04L 5/0016; H04W 72/044

(57) ABSTRACT

A method is provided. The method includes: mapping one or more sub-code blocks of one or more first codewords to one or more time and frequency resources, wherein the one or more sub-code blocks are interleaved; and sending one or more second codewords, wherein the one or more second codewords include at least one of the one or more sub-code blocks.

### CROSS-REFERENCE TO RELATED APPLICATIONS

This application is a continuation of International Patent Application PCT/CN2024/090923, filed on Apr. 30, 2024, which claims the benefit of U.S. Provisional Patent Application No. 63/526,073, filed on Jul. 11, 2023. The entire contents of these disclosures are hereby incorporated by reference.

### TECHNICAL FIELD

The present disclosure generally relates to the field of wireless communication, and in particular, to a method, apparatus and system for data transmission, and a computer readable storage medium.

### BACKGROUND

Two trends are observed toward 6G, one is the ever-crowded spectrum in the sub-3G bands, and the ever-increasing power saving demand.

The past generations of mobile communications (4G and 5G) have adopted higher frequency spectrums for larger bandwidth. However, due to the channel propagation characteristics, the coverage is much smaller than lower-frequency bands, say, sub-3 GHz. The power efficiency is also much lower. As a result, the operators are more willing to prioritize the use of lower bands for better coverage and power saving. As a result, the sub-3 GHz bands will become even more crowded.

A key target of 6G is to reduce the global carbon footprint, at least does not increase the net energy consumption of 5G. However, denser deployment of wireless devices is expected, which naturally increases the inter-cell and inter-device interference. Reducing the transmit energy will have the double benefits of energy saving and interference mitigation, however at the cost of lower received signal-to-interference-plus-noise ratio (SINR). This is a dilemma.

With the current technology, there are several schemes to save transmission energy, improve spectral efficiency and enhance SINR. The first scheme is link adaptation and Hybrid automatic repeat request (hybrid ARQ or HARQ), and the second scheme is power adaptation.

This background information is provided to reveal information believed by the applicant to be of possible relevance to the present disclosure. No admission is necessarily intended, nor should it be construed, that any of the preceding information constitutes prior art against the present disclosure.

### SUMMARY

According to a first aspect, a method for data transmission is provided. The method may be implemented by a transmitting apparatus, or modules in the transmitting apparatus (such as circuits, chips, or chip systems), or logic nodes, logic modules, or software that may perform all or some of the functions of the transmitting apparatus. In an example where the method is applied to a transmitting apparatus, the method comprises: mapping one or more sub-code blocks of one or more first codewords to one or more time and frequency resources, wherein the one or more sub-code blocks are interleaved; and sending one or more second codewords, wherein the one or more second codewords include at least one of the one or more sub-code blocks.

In such case, after being interleaved, the sub-code blocks will be mapped to time and frequency resources in a more dispersed manner. Therefore, the sub-code blocks may be mapped to time and frequency resources in a flexible way.

In some embodiments, the one or more sub-code blocks correspond to one or more feedback opportunities, and wherein a feedback of at least one of the one or more feedback opportunities indicates a decoding result of the one or more first codewords.

Since the sub-code blocks may be spread on the time resources, there will be more opportunity for the receiving apparatus to feedback. Thereby, the receiving apparatus may transmit the feedbacks timely.

In some embodiments, initial sub-blocks of at least two different first codewords are mapped to a same time resource.

In such case, the initial sub-blocks of the at least two different first codewords may be transmitted at the same time. Accordingly, the initial sub-blocks of the at least two different first codewords may be received and decoded at the same time. In this way, the two different first codewords may be decoded at an early time.

In some embodiments, at least two sub-blocks of two different first codewords are mapped to a same time resource.

In such case, the sub-blocks of the at least two different first codewords may be transmitted at the same time. Accordingly, the sub-blocks of the at least two different first codewords may be received and decoded at the same time. In this way, the two different first codewords may be decoded at an early time.

In some embodiments, at least two sub-blocks of two different first codewords are mapped to an equal number of frequency resources.

In some embodiments, the one or more sub-blocks are interleaved such that the one or more sub-blocks are mapped one by one.

In such case, after being interleaved, the sub-code blocks will be mapped to time and frequency resources in a more dispersed manner. Therefore, the sub-code blocks may be mapped to time and frequency resources in a flexible way.

In some embodiments, the one or more sub-blocks are interleaved includes: the one or more sub-blocks are interleaved through a row-in-column-out scheme.

In some embodiments, a number of rows of the row-in-column-out scheme is equal to the number of the one or more first codewords, and a number of columns of the row-in-column-out scheme is equal to the number of bits of the first codeword.

In some embodiments, the one or more sub-blocks are interleaved includes: the one or more sub-blocks are interleaved through a column-in-row-out scheme.

In some embodiments, a number of columns of the column-in-row-out scheme is equal to the number of the one or more first codewords, and a number of rows of the column-in-row-out scheme is equal to the number of bits of the first codeword.

In some embodiments, the method further comprises: obtaining an indication enabling mapping the one or more sub-code blocks of one or more first codewords to the one or more time and frequency resources, wherein the one or more sub-code blocks are interleaved.

According to a second aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: receiving one or more second codewords, wherein the one or more second codewords include at least one of one or more sub-code blocks of one or more first codewords; and the one or more sub-code blocks of the one or more first codewords are interleaved and mapped to one or more time and frequency resources; and decoding the one or more second codewords.

In some embodiments, the one or more sub-code blocks correspond to one or more feedback opportunities, wherein the feedback of at least one of the one or more feedback opportunities indicates a decoding result of the one or more first codewords.

In some embodiments, initial sub-blocks of at least two different first codewords are mapped to a same time resource.

In some embodiments, at least two sub-blocks of two different first codewords are mapped to a same time resource.

In some embodiments, at least two sub-blocks of two different first codewords are mapped to an equal number of frequency resources.

In some embodiments, the one or more sub-blocks are interleaved such that the one or more sub-blocks are mapped one by one.

In some embodiments, the one or more sub-blocks are interleaved includes: the one or more sub-blocks are interleaved through a row-in-column-out scheme.

In some embodiments, a number of rows of the row-in-column-out scheme is equal to the number of the one or more first codewords, and a number of columns of the row-in-column-out scheme is equal to the number of bits of the first codeword.

In some embodiments, the one or more sub-blocks are interleaved includes: the one or more sub-blocks are interleaved through a column-in-row-out scheme.

In some embodiments, a number of columns of the column-in-row-out scheme is equal to the number of the one or more first codewords, and a number of rows of the column-in-row-out scheme is equal to the number of bits of the first codeword.

In some embodiments, the method further comprises: obtaining an indication enabling the receiving the one or more second codewords, wherein the one or more second codewords include at least one of one or more sub-code blocks of one or more first codewords; and the one or more sub-code blocks of the one or more first codewords are interleaved and mapped to one or more time and frequency resources.

According to a third aspect, an apparatus is provided. The apparatus comprises a processor configured to cause the apparatus to perform the method for data transmission in the first aspect or the second aspect, or any possible implementation of the first aspect or the second aspect.

According to a fourth aspect, a computer-readable medium is provided. The computer-readable storage medium has stored thereon computer program instructions that, when executed by a processing circuit of a computer, cause the computer to implement the method for data transmission in the first aspect or the second aspect, or any possible implementation of the first aspect or the second aspect.

According to a fifth aspect, a computer program product is provided. The computer program product has instructions that, when executed by a computer, cause the computer to implement the method for data transmission in the first aspect or the second aspect, or any possible implementation of the first aspect or the second aspect.

According to a sixth aspect, a system is provided. The system comprises: a first apparatus for implementing the method for data transmission in the first aspect or any possible implementation of the first aspect; and a second apparatus for implementing the method for data transmission in the second aspect or any possible implementation of the second aspect.

The advantages brought by any design from the second to sixth aspects can be referred to the first aspect or the different designs of the first aspect, which will not be detailed here.

On the basis of the implementations provided in the above aspects, the present disclosure is able to provide more implementations by further combination.

### BRIEF DESCRIPTION OF THE DRAWINGS

FIG. 1 shows a communication system in which embodiments of the present disclosure may be implemented;

FIGS. 2A and 2B each show another communication system in which embodiments of the present disclosure may be implemented;

FIG. 3 shows an apparatus that wirelessly communicates with at least one apparatus in a communication system in accordance with some embodiments of the present disclosure;

FIG. 4A shows a block diagram of an electronic device or apparatus in accordance with some embodiments of the present disclosure;

FIG. 4B shows a block diagram of a sensing management function entity in accordance with some embodiments of the present disclosure;

FIG. 5A shows a schematic diagram of different redundancy versions (RVs) in the related art;

FIG. 5B shows an example feedback mechanism in the related art;

FIG. 6 is a schematic diagram of method for data transmission in accordance with some embodiments of the present disclosure;

FIGS. 7A and 7B are schematic diagrams of CB-to-TB-to resource mapping in accordance with some embodiments of the present disclosure;

FIG. 8 is a signaling chart in accordance with some embodiments of the present disclosure;

FIG. 9 is another schematic diagrams of CB-to-TB-to resource mapping in accordance with some embodiments of the present disclosure;

FIG. 10 is a schematic diagram of a coding chain in accordance with some embodiments of the present disclosure;

FIG. 11 is a schematic diagram of concatenation in accordance with some embodiments of the present disclosure;

FIG. 12 is another schematic diagram of a coding chain in accordance with some embodiments of the present disclosure;

FIG. 13 is a schematic diagram of interleaver in accordance with some embodiments of the present disclosure;

FIG. 14 is a schematic diagram of interleaving in accordance with some embodiments of the present disclosure;

FIG. 15 is another schematic diagram of interleaver in accordance with some embodiments of the present disclosure;

FIG. 16 is another schematic diagram of interleaving in accordance with some embodiments of the present disclosure;

FIG. 17 yet is another schematic diagrams of CB-to-TB-to resource mapping in accordance with some embodiments of the present disclosure;

FIG. 18 yet is another schematic diagrams of CB-to-TB-to resource mapping in accordance with some embodiments of the present disclosure;

FIG. 19 is a schematic diagram of mode selection in accordance with some embodiments of the present disclosure; and

FIG. 20 is another schematic diagram of mode selection in accordance with some embodiments of the present disclosure.

### DETAILED DESCRIPTION

To solve the above problems, the present disclosure provides a method for data transmission, which includes multiple solutions. The solutions can be implemented in next-generation mobile and wireless network service, cloud and edge computing service, and sensing services. The method will be particularly useful for automated manufacturing systems in smart factories. It applies to other intelligent vertical scenarios such as ports, delivery systems and medical systems.

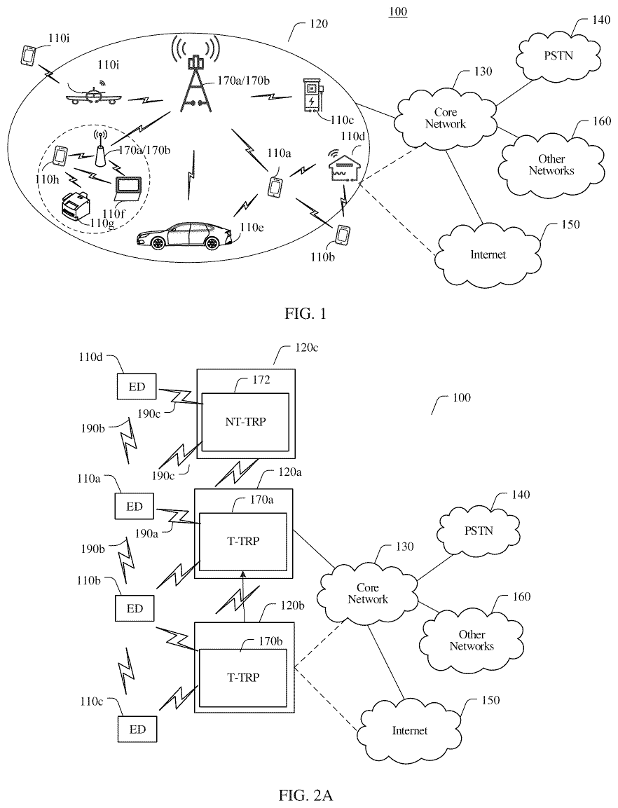

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

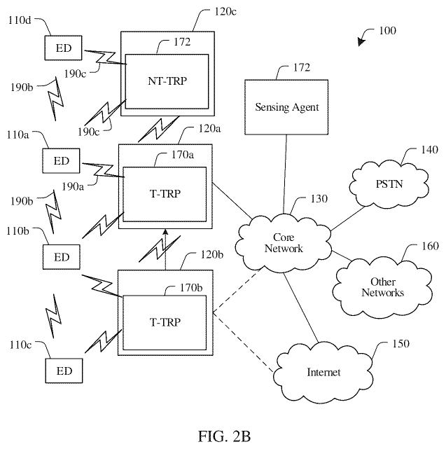

FIG. 2A illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

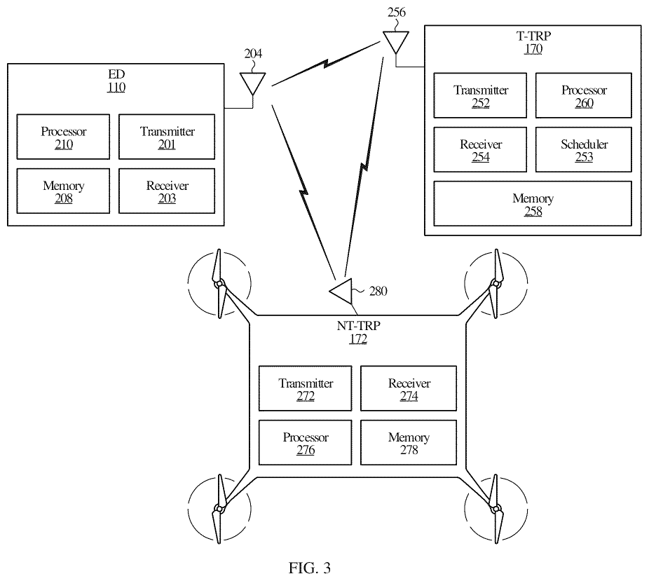

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In different systems, the CU (or the CU-CP and the CU-UP), the DU, or the RU may also have different names, but a person skilled in the art may understand meanings thereof. For example, in an ORAN system, a CU may also be referred to as an open CU (O-CU), a DU may also be referred to as an open DU (O-DU), and a CU-CP may also be referred to as an open CU-CP (O-CU-CP). The CU-UP may also be referred to as an open CU-UP (O-CU-UP), and the RU may also be referred to as an open RU (O-RU).

Any one of the CU (or the CU-CP, the CU-UP), the DU, and the RU may be implemented by using a software module, a hardware module, or a combination of a software module and a hardware module.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

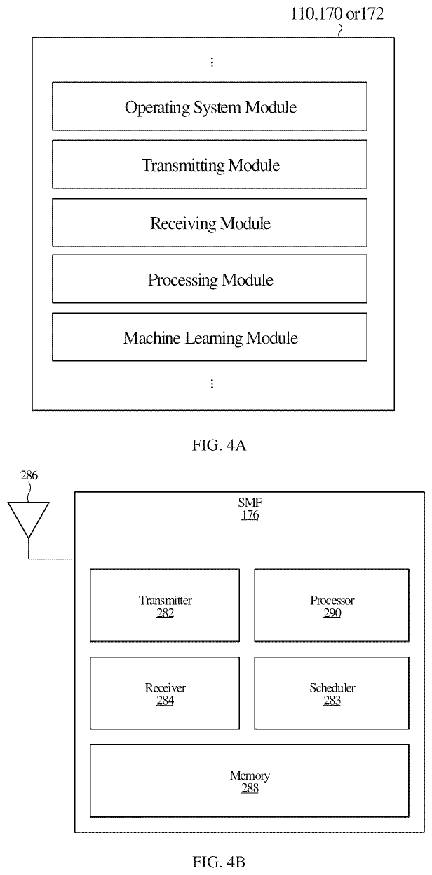

One or more steps of the embodiment methods provided herein may be performed by corresponding units or modules, according to FIG. 4A. FIG. 4A illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### 6G Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept.” For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of ims each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Timing Reference Point

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xxo:yyo:zz), to a frame boundary, where xxo, yyo, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 (an example of ED 110) to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

### 6G Integrated Sensing and Communication

### Generic Background

User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

### Sensing Node, Sensing Management Function

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2B, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

As shown in FIG. 4B, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy.

### Sensing Channel

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C could be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

### Radar

The term RADAR originates from the phrase Radio Detection and Ranging; however, expressions with different forms of capitalization (i.e., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### Half-Duplex and Full-Duplex

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

### Sensing Signal Waveform and Frame Structure

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp,” orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

### Precoding

Precoding as used herein may refer to any coding operation(s) or modulation(s) that transform a [ . . . ] input signal into a [ . . . ] output signal. Precoding may be performed in different domains, and typically transform the input signal in a first domain to an output signal in a second domain. Precoding may include linear operations.

### 6G Integrated TN & NTN

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### 6G MIMO

Multiple input multiple-output (MIMO) technology allows an antenna array of multiple antennas to perform signal transmissions and receptions to meet high transmission rate requirement. The above ED 110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and a ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:
Panel: unit of antenna group, or antenna array, or antenna sub-array which can control its Tx or Rx beam independently.
Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

### 6G AI/ML

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

### Data Collection

Data is the very important component for AI/ML techniques. Data collection is a process of collecting data by the network nodes, management entity, or UE for the purpose of AI/ML model training, data analytics and inference.

### AI/ML Model Training

AI/ML model training is a process to train an AI/ML Model by learning the input/output relationship in a data driven manner and obtain the trained AI/ML Model for inference.

### AI/ML Model Inference

A process of using a trained AI/ML model to produce a set of outputs based on a set of inputs.

### AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### AI/ML Model Testing

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicator (KPI) s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

### Supervised Learning:

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Supervised learning can be further divided into two types: Classification and Regression. Classification is used when the output of the AI/ML model is categorical i.e. with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

### Federated Learning:

Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, e.g, the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement:intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface.” In some embodiments, there may be two types of AI operation in an AI enabled air interface: both the network and the UE implement learning; or learning is only applied by the network.

The following are acronyms, abbreviations, and key terms:

| | |
|---|---|
| Full Name | Acronym/Abbreviation/Initialism |

Communication related

| | |
|---|---|
| Long Term Evolution | LTE |
| New Radio | NR |
| Forward error correction | FEC |
| Multiple Access | MA |
| Quality of Service | QoS |
| low-density parity check codes | LDPC |
| cyclic redundancy check | CRC |
| ultra-reliable low | uRLLC |
| latency communications | |
| Enhanced mobile broadband | eMBB |
| massive Machine | mMTC |
| Type Communications | |
| non-terrestrial networks | NTN |
| Internet of Things | IoT |
| Bit Error Rate | BER |
| Block Error Rate | BLER |
| Packet Error Rate | PER |
| Spectral Efficiency | SE |
| Hybrid automatic repeat request | HARQ |
| Channel Quality Indicator | CQI |
| Modulation Coding Scheme | MCS |
| gNodeB or 5G base station | gNB |
| user equipment | UE |
| Radio Resource Control | RRC |
| Radio Network Temporary Identifier | RNTI |
| Uplink Control Information | UCI |
| Downlink Control Information | DCI |
| Physical Broadcast Channel | PBCH |
| Half-radio frame bit | HRF |
| Synchronization Signal Block | SSB |
| unequal error protection | UEP |
| variable node | VN |
| check node | CN |
| Log-likelihood ratio | LLR |
| Successive cancellation | SC |
| Successive cancellation list | SCL |
| Belief propagation | BP |

With the current technology, there are several schemes to save transmission energy, improve spectral efficiency and enhance SINR. The first scheme is link adaptation and Hybrid automatic repeat request (hybrid ARQ or HARQ), and the second scheme is power adaptation.

HARQ is a combination of high-rate forward error correction (FEC) and automatic repeat request (ARQ). If the initial transmission fails, a retransmission is automatically requested until the successful decoding of the packet. The retransmission is conducted upon request, and is scheduled by a base station (BS).

For data channel, the BS will schedule a modulation and coding scheme (MCS) such that the target BLER is around 0.1, which means one out of ten code blocks (CB) will have decode error. In case of an error, a retransmission request is sent via the negative acknowledgement (NACK) signal.

In 4G and 5G, the HARQ mechanism is also called the “stop-and-go” paradigm, where the transmitter will stop transmitting a certain packet at some point, and wait for the ACK/NACK feedback. Depending on the feedback, the transmitter may retransmit a part of the current packet, or transmit a new packet. The part of a packet is called a redundancy version (RV). For 5G LDPC, there are all four RVs (i.e., RV0, RV1, RV2, and RV3), defined by their starting positions in the base graph, shown in FIG. 5A.

As shown in FIG. 5B, the transmitter transmits RV0 of a Transport Block (TB), and then stops transmitting and waits for corresponding feedback (e.g., ACK/NACK). After receiving RV0, the receiver decodes RV0. In a case where RV0 is not decoded successfully, the receiver feeds back a NACK to the transmitter. After receiving the NACK, the transmitter (e.g., the BS) will find a next vacant time-frequency resource block to retransmit a redundancy version (e.g., RV2) corresponding to the initial transmission. After transmitting RV2, the transmitter stops transmitting and waits for corresponding feedback (e.g., ACK/NACK). After receiving RV2, the receiver (e.g., the UE) will combine the two transmissions and re-decode that packet (e.g., RV0 and RV2), which will typically lead to a greater-than-3 dB gain. In a case where the packet is decoded successfully, the receiver feeds back an ACK to the transmitter. After receiving the ACK, the transmitter stops transmitting the TB, and starts transmitting RV0 of a next TB.

As for power adaptation, due to channel (CQI) estimation error and unpredictable interference from neighboring cells and devices, the perceived SINR may be insufficient for reliable communications. In these cases, an effective method is to ramp up transmit power, until the packet is successfully decoded.

The link adaptation and HARQ methods suffer from low spectrum efficiency and excessive latency. The power adaptation suffers from low spectrum efficiency and low power efficiency. Disadvantages of the current link adaptation, HARQ and power adaption are mainly (i) longer latency, (ii) lower spectrum efficiency and (iii) lower power efficiency.

In real-time acknowledgement amid transmissions (RAAT) scheme, several fast ACK/NACK reporting methods are proposed for early termination of a packet's transmission and decoding. The method exploits the benefits of a kind of rateless channel codes, which is decodable as soon as the number of received code bits exceeds a threshold. The fast decoding and acknowledgements methods feature two aspects:

### Multiple Decoding Attempts

### Multiple ACK/NACK Opportunities

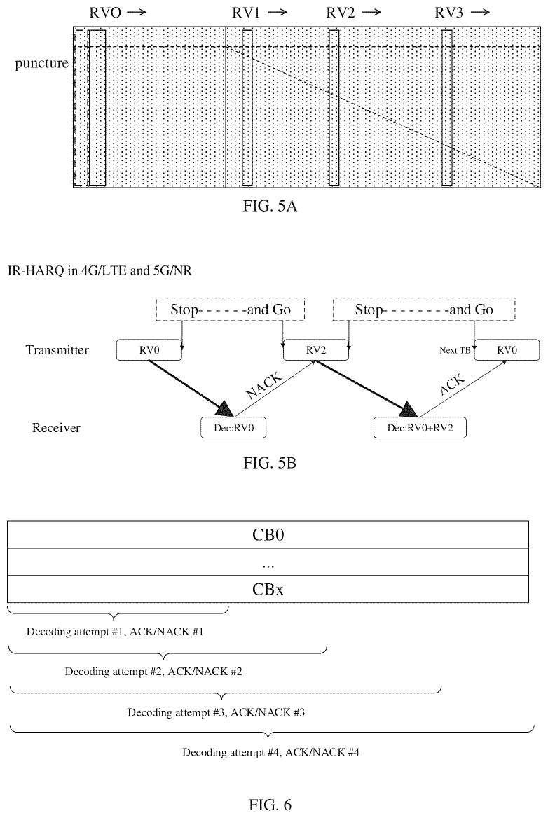

As seen in FIG. 6, the proposed method differs from existing HARQ scheme because a transmitter does not need to wait for a NACK before going on to transmit the remaining code bits (or RVs) of the current packet. The transmitter consecutively transmits the CBs of a TB until it receives positive feedback from the receiver. The positive feedback indicates the TB is successfully decoded. During transmission of the CBs, there are multiple decoding attempts (e.g., Decoding attempt #1, Decoding attempt #2, Decoding attempt #3, and Decoding attempt #4) for the receiver to perform decoding. Each decoding attempt corresponds to a feedback opportunity. The receiver may feed back an ACK or a NACK at the corresponding feedback opportunity. Each feedback opportunity also corresponds to a stopping opportunity for the transmitter to stop transmitting the CBs.

### Resource Mapping on Spatial-, Time-, and Frequency-Domain

On the other hand, the coded bits of a packet (coded block) is usually modulated (e.g., to QAM symbols) and mapped to spatial-domain, time-domain, frequency-domain resources and sent over the air. Because current wideband wireless systems typically map the bits (symbols) to spatial domain first, time domain next and finally frequency domain, a packet transmission duration on the time domain is usually very short.

The disadvantages of link adaptation and HARQ is extra latency, especially when an initial transmission fails to be decoded, because the feedback, rescheduling and retransmission takes a much longer time. This is a common case if the scheduled code rate is greater than the channel capacity, as a result of poor link adaptation and imperfect channel (CQI) estimation. The main source of delay is the waiting time for scheduling ACK feedback and retransmission.

In conventional solutions, the time domain transmission duration of a single code block (CB) or transport block (TB) is usually very short, which leaves little room for fast feedback and stop.

### In More Specific Terms:

The feedback delay T_{feedback} is the sum of T_{RTD} the round-trip signal propagation delay and T_{proc} the processing time at the receiver (including demodulation, decoding, etc.). In other words, T_{feedback}=T_{RTD}+T_{proc}.

Denote by Tₜᵣₐₙₛᵢₛₛᵢₒₙ the transmission duration of a packet.

If Tₜᵣₐₙₛᵢₛₛᵢₒₙ<T_{feedback}, then early stop will not have any effect because by the time an ACK arrives at the transmitter, the packet has already been fully transmitted.

The technical problems to be resolved are to address the disadvantages of prior arts. In a nutshell, we want to spread the transmission of a codeword (CB/TB) on the time domain to provide more early stopping opportunities.

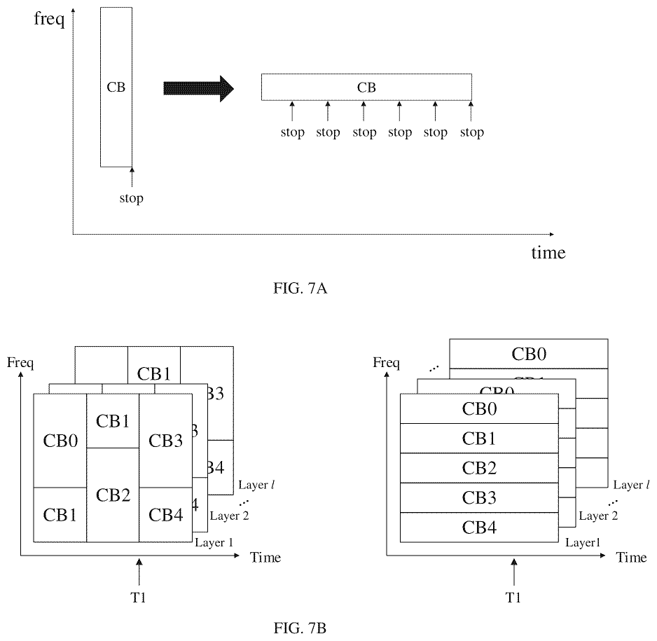

As shown on the left hand side of FIG. 7A, in conventional solutions, the CB is mapped to a relatively small amount of time resources and large amount of frequency resources. In such case, the receiver may take only one decoding attempt by the end of the transmission of the CB. Accordingly, there will be only one feedback opportunity for the receiver to transmit feedback about the decoding result of the TB consisting of the CB. In addition, since the feedback opportunity corresponds to the stopping opportunity for the transmitter, there will be only one stopping opportunity for the transmitter to stop transmitting the CB.

As shown on the right hand side of FIG. 7A, in the present disclosure, the CB is mapped to a relevant large amount of time resources and small amount of frequency resources. In such case, the receiver may take multiple decoding attempts during the transmission of the CB. Accordingly, there will be multiple feedback opportunities for the receiver to transmit feedbacks about the decoding result of the TB consisting of the CB. In addition, since the feedback opportunities correspond to the stopping opportunities for the transmitter, there will be multiple stopping opportunities for the transmitter to stop transmitting the CB. Therefore, the receiver may decode the CB successfully before an entire CB is transmitted. In other words, the transmitter does not have to transmit the entire CB, and the receiver does not have to receive and decode the entire CB. In this way, energy consumption of both the transmitter and the receiver will be reduced.

Although the above idea is straightforward, we will try to address the problem by proposing detailed and standard-friendly methods.

The proposed method is using new resource mapping rules to spread the transmission of each codeword.

An overview of our CB/TB mapping rule, and its difference from existing rules are illustrated in FIG. 7B.

For example, a TB includes CB0, CB1, CB2, CB3, and CB4. The transmitter will stop transmitting the CBs once the TB is successfully decoded (i.e., all of CB0, CB1, CB2, CB3, and CB4 are successfully decoded).

When the current CB-to-TB-to resource mapping is adopted, even if there are multiple feedback opportunities during transmission of each CB, the transmitter has to transmit the CBs until the last CB (i.e., the CB which is transmitted at the latest time) is decoded successfully. In such case, the decoding latency is governed by the last CB(s) transmitted by the transmitter. For example, as shown on the left hand side of FIG. 7B, T1 is the time at which the transmitter starts transmitting the last CBs (e.g., CB3 and CB4). In such case, even if CB0, CB1, CB2 are successfully decoded before T1 (e.g., before the entire CB0, CB1, CB2 are transmitted), it is still not possible to decode the TB successfully before T1 because CB3 and CB4 have not been transmitted before T1.

When the new CB-to-TB-to resource mapping provided by some embodiments in the present disclosure is adopted, the CBs span the same physical time resources. In such case, the transmitter starts transmitting the CBs at the same time so that there will not be a CB transmitted last by the transmitter. As show on the left hand side of FIG. 7B, the transmitter starts transmitting all the CBs before T1. Accordingly, the receiver starts decoding all the CBs before T1. Since there are multiple feedback opportunities during transmission of each CB, the transmitter will stop transmitting the CBs once the all the CBs are decoded successfully. Compared to the conventional solutions described above, it is possible to decode the TB before T1 in some embodiments of the present disclosure.

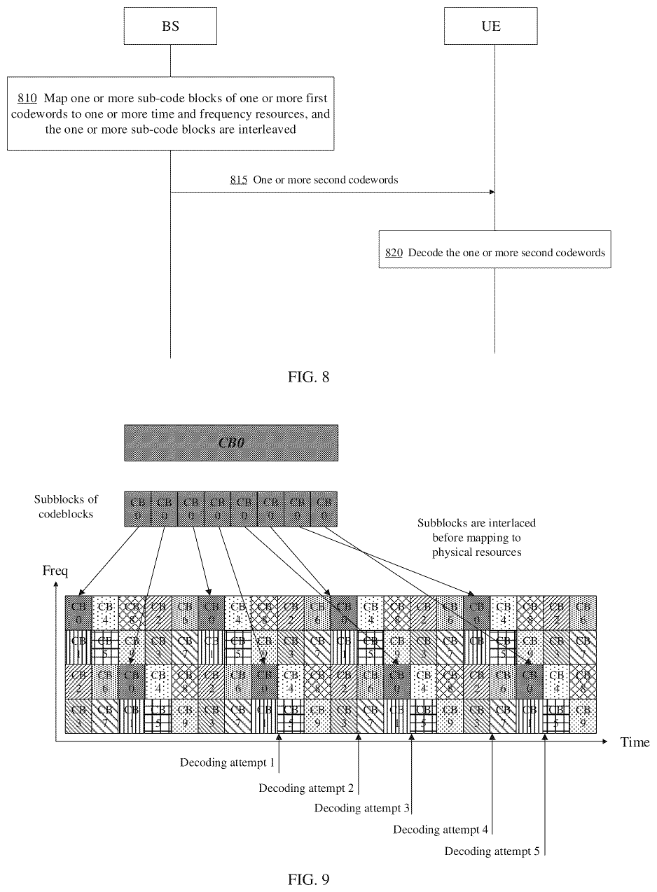

Various embodiments of the present disclosure will be described below by way of example. The following embodiments will be illustrated by taking an example where the transmitter/encoder is a BS and the receiver/decoder is a UE. Reference is now made to FIG. 8, which shows a signaling chart for data transmission according to some embodiments of the present disclosure. The signaling chart 800 involves the BS and the UE.

In step 810, the BS maps one or more sub-code blocks of one or more first codewords to one or more time and frequency resources, and the one or more sub-code blocks are interleaved.

The one or more first codewords are encoded from information bits. A sub-code block refers to a sub set of coded bits in a codeword. The term “sub-code block” may be interchangeable with “subblocks.” A codeword may be a Transport Block (TB), a Code Block Group (CBG), or a Code Block (CB), which is not limited in the present disclosure. The following embodiments will be illustrated by taking an example where the codeword is a CB.

Because a CB may be very big, e.g., thousands of bits, per-bit interleaving and resource mapping may be less efficient. To resolve this issue, the transmitter may first divide a CB into multiple subblocks, and then interleave these subblocks, before mapping these subblocks to target time and frequency positions. For example, after being encoded, each CB is further segmented into subblocks, and the subblocks are interleaved before resource mapping.

After being interleaved, the subblocks will be mapped to time and frequency resources in a more dispersed manner.

The terms “interleave,” “interleaving,” and “interleaved” are interchangeable with “interlace,” “interlacing,” and “interlaced” respectively.

In step 815, the BS sends one or more second codewords, and the second codeword includes at least one of the one or more sub-code blocks a first codeword, and the first codeword includes the one or more CBs. Accordingly, the UE receives the one or more second codewords.

In some embodiments, the subblocks are interleaved and then may be mapped to time and frequency resources in a more dispersed manner.

Referring to FIG. 9, each block represents a time-frequency block such as a resource element (RE) or a resource element block (REB). The area of a block may reflect the number of bits transmitted on it.

In an example shown in FIG. 9, the TB includes ten CBs (e.g., CB0, CB1, CB2, CB3, CB4, CB5, CB6, CB7, CB8 and CB9). Each of the ten CBs includes eight subblocks. For example, CB0 includes eight subblocks (e.g., eight CB0s). The eight CB0s are the multiple subsets of code bits encoded from the same payload bits. The eight CB0s may contain the same or different coded bits. Similarly, CB1 includes eight subblocks (e.g., eight CB1s); CB2 includes eight subblocks (e.g., eight CB2s); CB3 includes eight subblocks (e.g., eight CB3s); CB4 includes eight subblocks (e.g., eight CB4s); CB5 includes eight subblocks (e.g., eight CB5s); CB6 includes eight subblocks (e.g., eight CB6s); CB7 includes eight subblocks (e.g., eight CB7s); CB8 includes eight subblocks (e.g., eight CB8s); CB9 includes eight subblocks (e.g., eight CB9s).

In the above example, the 8 subblocks of the CB may be the 8 redundancy versions (RVs).

In practice, 8, 10, 12, 16, 24, 32 redundancy versions may be defined to support fine-grained decoding attempts. The number of RVs of a CB is not limited.

In an implementation, the subblocks are first interleaved. For example, the subblocks are interleaved into CB0-CB1-CB2-CB3-CB4-CB5-CB6-CB7-CB8-CB9-CB0-CB1-CB2 . . . -CB7-CB8-CB9.

After being interleaved, the subblocks are mapped to time and frequency resources. For example, the subblocks shown in FIG. 9 are mapped along the frequency domain, and then on the time domain. Subblocks CB0, CB1, CB2 and CB3 (in the first column) are mapped along the frequency domain in order; then CB4, CB5, CB6 and CB7 (in the second column) are mapped along the frequency domain in order; after that, CB8, CB9, CB0 and CB1 (in the third column) are mapped along the frequency domain in order; . . . at last, CB6, CB7, CB8 and CB9 (in the last column) are mapped along the frequency domain in order.

Interleaving of the subblocks may help the CBs to be mapped to time resources in a more dispersed manner, and the transmission of subblocks of the same CB will spread on the time domain. Thus it may improve the flexibility of transmission of the one or more CBs.

In some cases, there are multiple feedback opportunities during transmission of a CB. Feedback opportunities refers to possible time instants/transmission positions for UCI reports transmitted on PUCCH and PUSCH channels. For example, a feedback opportunity refers to a possible transmission time/transmission position for a UE feedback (e.g., ACK/NACK). The one or more feedback opportunities may be referred to as transmission granularity (i.e., Tx granularity) and/or feedback granularity (e.g., ACK/NACK granularity).

In some embodiments, one or more subblocks of the one or more CBs correspond to a feedback opportunity. The feedback is about the decoding result of the one or more CBs after receiving one or more subblocks.

In some cases, there are multiple decoding opportunities and feedback opportunities during transmission of a CB. The decoding opportunities are for the UE to perform decoding, and the feedback opportunities are for the UE to feed back the result of decoding. Since the BS will stop transmitting the codeword once it receives the positive feedback of the codeword, there will be more early stopping opportunities for the BS to stop transmitting the codeword.

In an implementation, after receiving the first a few symbols, the UE starts decoding attempts for all CBs. For example, after receiving four CB0s, the UE starts decoding at the decoding attempts. There is a decoding attempt once a CB0 is received. As shown in FIG. 9, the first four CB0s correspond to “Decoding attempt 1.” Each CB0 after the first CB0s corresponds to “Decoding attempt 2,” “Decoding attempt 3,” “Decoding attempt 4,” and “Decoding attempt 5” respectively.

In some cases, each decoding attempt corresponds to a feedback opportunity. In such case, the first four CB0s correspond to a feedback opportunity. Each CB0 after the first four CB0s corresponds to a feedback opportunity respectively. Once all the CBs are successfully decoded, the UE will feed back an ACK at the corresponding feedback opportunity. This way, the CBs can enjoy both the benefit of frequency-domain diversity and time-domain spreading to enable early stop.

In step 820, the UE decodes the first codeword.

In some embodiments, some new UE behaviors are also needed:

After receiving the first a few symbols, UE start decoding attempts for multiple CBs (e.g., all CBs). In this way, the CBs may be decoded successfully in an early time.

Once all CBs (i.e., all CBs of a TB) are successfully decoded (pass CRC check), the buffer for all CBs can be cleared, and the receiver can be turned off. In this way, energy consumption of the receiver will be reduced.

In conventional solutions, for narrow band systems, the CBs are mapped along the frequency domain, and then on the time domain. Since the subblocks have been interleaved before resource mapping, conventional solutions for resource mapping may be adopted as well. In other words, since the sub-blocks of the CBs are interleaved before resource mapping, the CBs may be spread on the time resources even conventional solutions for resource mapping are adopted. Therefore, the solutions proposed in the present disclosure is backward compatible.

In some embodiments, the one or more sub-blocks are interleaved through CB concatenation. The one or more sub-blocks are interleaved such that the bits are obtained from each CB one by one. One possible standard description is by modifying the current CB concatenation, such that code bits of all CBs are interleaved when doing CB concatenation. The benefit is simpler description and lower implementation complexity.

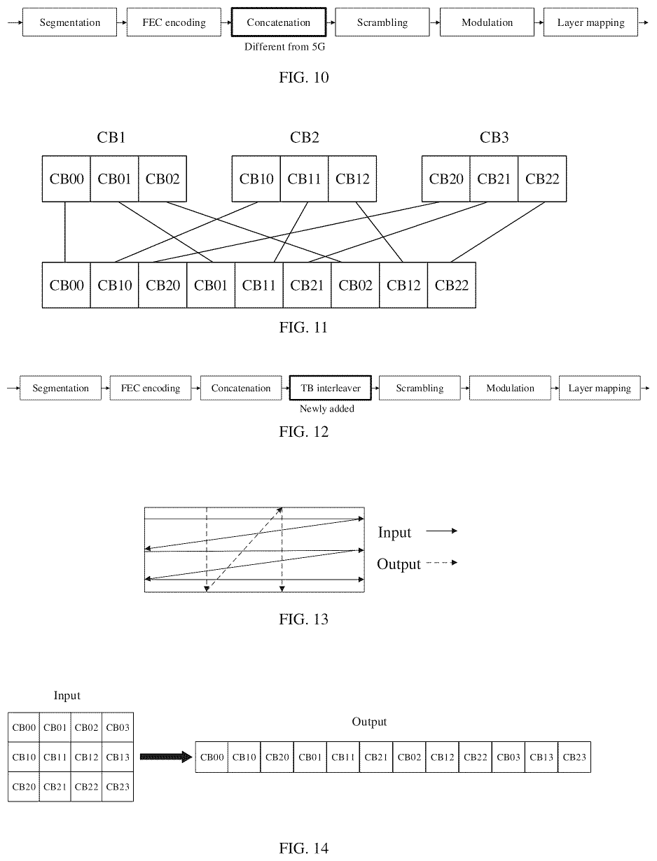

The coding chain is illustrated in FIG. 10. The coding chain includes segmentation, FEC encoding, concatenation, scrambling, modulation, layer mapping etc. After the CBs are encoded and rate matched, the CBs are interleaved through concatenation.

In the conventional solutions, when concatenating multiple CBs into one TB, the CBs are concatenated one by one. For example, there are three CBs (e.g., CB0, CB1, and CB2) to be concatenated. During concatenation, CB0 is retrieved first. Then, CB1 is retrieved and the first bit of CB1 is concatenated with the last bit of CB0. After that, CB2 is retrieved and the first bit of CB2 is concatenated with the last bit of CB1. In this way, CB0, CB1, and CB2 are concatenated into: CB0-CB1-CB2.

In some embodiments of the present disclosure, when concatenating multiple CBs into one TB, we can take turns to collect bits from each CB, which will effectively interlace the bits from multiple CBs. In other words, compared to the conventional solutions where the entire CBs are retrieved one by one, in this embodiment, each sub-block of each CB are retrieved one by one.

In an example shown in FIG. 11, there are three CBs (e.g., CB1, CB2, and CB3) to be concatenated. CB1 includes sub-blocks CB00, CB01, CB02; CB2 includes sub-blocks CB10, CB11, CB12; and CB3 includes sub-blocks CB30, CB31, CB32. During concatenation, in the first round, CB00 is retrieved first. Then, CB10 is retrieved and the first bit of CB10 is concatenated with the last bit of CB00. After that, CB20 is retrieved and the first bit of CB20 is concatenated with the last bit of CB10.

In the second round, CB01 is retrieved and the first bit of CB01 is concatenated with the last bit of CB20. Then, CB11 is retrieved and the first bit of CB11 is concatenated with the last bit of CB01. After that, CB21 is retrieved and the first bit of CB21 is concatenated with the last bit of CB11.

In the last round, CB02 is retrieved and the first bit of CB02 is concatenated with the last bit of CB21. Then, CB12 is retrieved and the first bit of CB12 is concatenated with the last bit of CB02. After that, CB22 is retrieved and the first bit of CB22 is concatenated with the last bit of CB12.

In this way, CB1, CB2, and CB3 are concatenated into: CB00-CB10-CB20-CB01-CB11-CB21-CB02-CB12--CB22.

Note that the number of the CBs and the number of sub-blocks in each CB are not limited in the present disclosure.

A possible standard description is below.

The input bit sequence for the code block concatenation block is the sequence fᵣₖ, for r=0, . . . , C−1 and k=0, . . . , Eᵣ−1, where Cis the total number of the CBs, and Eᵣ is the number of rate matched bits for the r-th code block. The output bit sequence from the code block concatenation block is the sequence gₖ for k=0, . . . , G−1. The code block concatenation consists of interlacing the rate matching outputs for the different code blocks.

The input bit sequence for the code block concatenation block is:

$${f}_{00} , {f}_{01} , {f}_{02} , … , {f}_{0 ( Er - 2 )} , {f}_{0 ( Er - 1 )} ,$$

$${f}_{10} , {f}_{11} , {f}_{12} , … , {f}_{1 ( Er - 2 )} , {f}_{1 ( Er - 1 )} ,$$

$${f}_{20} , {f}_{21} , {f}_{22} , … , {f}_{2 ( Er - 2 )} , {f}_{2 ( Er - 1 )} ,$$

$$…$$

$$…$$

$${f}_{( C - 2 ) 0} , {f}_{( C - 2 ) 1} , {f}_{( C - 2 ) 2} , … , {f}_{( C - 2 ) ( Er - 2 )} , {f}_{( C - 2 ) ( Er - 1 )} ,$$

$${f}_{( C - 1 ) 0} , {f}_{( C - 1 ) 1} , {f}_{( C - 1 ) 2} , … , {f}_{( C - 1 ) ( Er - 2 )} , {f}_{( C - 1 ) ( Er - 1 )} .$$

The output bit sequence from the code block concatenation block is the sequence gₖ for k=0, . . . , G−1.

$${g}_{0} = {f}_{00} , {f}_{10} , {f}_{20} , … , {f}_{( C - 2 ) 0} , {f}_{( C - 1 ) 0} ,$$

$${g}_{1} = {f}_{01} , {f}_{11} , {f}_{21} , … , {f}_{( C - 2 ) 1} , {f}_{( C - 1 ) 1} ,$$

$${g}_{2} = {f}_{02} , {f}_{12} , {f}_{22} , … , {f}_{( C - 2 ) 2} , {f}_{( C - 1 ) 2} ,$$

$$…$$

$$…$$

$${g}_{( Er - 2 )} = {f}_{0 ( Er - 2 )} , {f}_{1 ( Er - 2 )} , {f}_{2 ( Er - 2 )} , … , {f}_{( C - 2 ) ( Er - 2 )} , {f}_{( C - 1 ) ( Er - 2 )} ,$$

$${g}_{( Er - 1 )} = {f}_{0 ( Er - 1 )} , {f}_{1 ( Er - 1 )} , {f}_{2 ( Er - 1 )} , … , {f}_{( C - 2 ) ( Er - 1 )} , {f}_{( C - 1 ) ( Er - 1 )} .$$

The interleaving process performed by the concatenation block may also be expressed in pseudo code as:

```
Set k=0
Set j=0
while j< max(Eₒ,...,E_{C-1})
for r=0,...,C−1
  if j<Eᵣ
    gₖ = fᵣⱼ
    k = k+1
  end if
end for
j = j+1
end while
```

In such case, the one or more sub-blocks are interleaved through CB concatenation. The one or more sub-blocks are interleaved such that the bits are obtained from each CB one by one.

Alternatively, spreading the transmission of the codewords on time domain can be achieved implicitly through some interleaver design. The benefit is simpler description and lower implementation complexity.

In some embodiments, we may add a new interleaver (e.g., TB interleaver) between concatenation and scrambling to achieve the same goal of spreading the CBs in the time domain.

As shown in FIG. 12, a TB interleaver is added to the coding chain. In such case, the coding chain includes segmentation, FEC encoding, concatenation, interleaving, scrambling, modulation, layer mapping etc. After the CBs are encoded and rate matched, the CBs are interleaved by the TB interleaver. The key module is an additional interleaver after CB segmentation such that they span the same physical time resources, when assembling a TB from multiple CBs.

Generally speaking, all interleaver designs will have benefits. For simplicity, we advocate the use of the following block interleaver: block interleaver (row-in-column-out) or block interleaver (column-in-row-out). Note that the type of interleaver is not limited in the present disclosure.

In an implementation, the one or more sub-blocks are interleaved through a row-in-column-out scheme. For example, the one or more sub-blocks are interleaved through a block interleaver (row-in-column-out) which is shown in FIG. 13.

In such case, the number of rows (i.e., input rows) equals to the number of the one or more CBs, and the number of columns (i.e., input columns) equals to the number of bits of the first codeword. The first codeword may be the rate matched codeword. In such case, the number of columns equals to the number of bits in the codeword which is of the rate matched code length.

For example, CB0 includes sub-blocks CB00, CB01, CB02 and CB03; CB1 includes sub-blocks CB10, CB11, CB12 and CB13; CB2 includes sub-blocks CB20, CB21, CB22 and CB23. The length of each sub-blocks is 20 bits, and the length of each of CB0, CB1, CB2, and CB3 is 80 bits which is the rate matched code length.

As shown in FIG. 14, CB0, CB1 and CB2 are interleaved through a row-in-column-out scheme. The input to the interleaver is: CB00-CB01-CB02-CB03-CB10-CB11-CB12-CB13-CB20-CB21-CB22-CB23. In such case, the number of rows is three which equals to the number of the three CBs. The number of columns is 80 which equals to the number of bits of the rate matched codeword CB0, CB1, and CB2.

The order of the output of the interleaver is CB00-CB10-CB20-CB01-CB11-CB21-CB02-CB12-CB22-CB03-CB13-CB23.

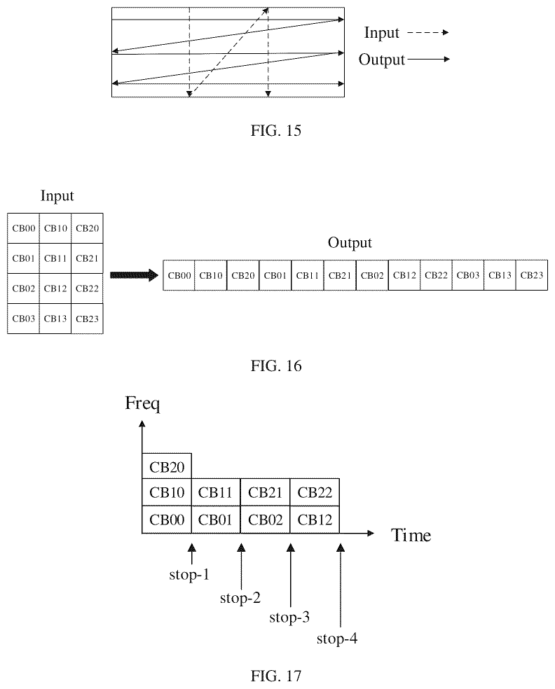

In another implementation, the one or more sub-blocks are interleaved includes: the one or more sub-blocks are interleaved through a column-in-row-out scheme. For example, the one or more sub-blocks are interleaved through a block interleaver (column-in-row-out) which is shown in FIG. 15.

In such case, the number of columns (i.e., input columns) equals to the number of the one or more CBs, and the number of rows (input roes) equals to the number of bits of the first codeword. The first codeword may be the rate matched codeword. In such case, the number of rows equal to the number of bits in the codeword which is of the rate matched code length.

As shown in FIG. 16, CB0, CB1 and CB2 are interleaved through a column-in-row-out scheme. The input to the interleaver is: CB00-CB01-CB02-CB03-CB10-CB11-CB12-CB13-CB20-CB21-CB22-CB23. In such case, the number of columns is three which equals to the number of the three CBs. The number of rows is 80 which equals to the number of bits of the rate matched codeword CB0, CB1, and CB2.

The order of the output of the interleaver is CB00-CB10-CB20-CB01-CB11-CB21-CB02-CB12-CB22-CB03-CB13-CB23. The rate matched codeword is 80 bits which is the total length of four sub-blocks. In such case, there are four sub-blocks in each row, and the number of rows equals to the number of bits of the rate matched codeword. CB00, CB10, CB20 and CB01 are in the first row that is output by the interleaver; CB11, CB21, CB02 and CB12 are in the second row that is output by the interleaver; CB22, CB03, CB13 and CB23 are in the third row that is output by the interleaver.

The present disclosure provides another method for data transmission.

Because a TB comprises a lot of CBs, an early stop requires that all CBs are correctly decoded. This suggests it is better to align the multiple CBs in a TB in the time domain. To achieve this, some resource element (RE) mapping rules are desired.

In some embodiments, the initial sub-blocks of at least two different CBs are transmitted over a same time resource. In other words, the initial sub-blocks of at least two different CBs are aligned. The initial subblock of a CB is the code bits with the smallest indices, or those first transmitted. For example, when information bits are encoded into a CB (e.g., CB0), the information bits will be encoded into sub-blocks of CB0 (e.g., CB00, CB01 and CB02) sequentially. In such case, CB00 will be the initial sub-block which is encoded at the earliest time compared to CB01 and CB02.

As shown in FIG. 17, the TB includes CB0, CB1 and CB2. CB0 includes CB00, CB01 and CB02; CB1 includes CB10, CB11 and CB12; CB2 includes CB10, CB11 and CB12. The initial sub-blocks of CB0, CB1 and CB2 is CB00, CB10 and CB20, respectively. CB00, CB10 and CB20 are mapped to a same time resource (e.g., a same symbol) so that CB00, CB10 and CB20 will be transmitted over a same time resource. In this case, the UE will start to decode the initial sub-blocks of CB0, CB1 and CB2 at the same time which is also the time at which the UE start decoding the TB.

In an example, CB0 is successfully decoded after CB00 and CB01 are transmitted and decoded. CB1 is successfully decoded after CB10 and CB11 are transmitted and decoded. CB2 is successfully decoded after CB20 and CB21 are transmitted and decoded. In such case, the UE may feed back an ACK at “stop-3” which is the feedback opportunity immediate after CB21 is successfully decoded. In this way, the UE may successfully decode the TB (i.e., all the CBs) at an early time before the entire TB is transmitted. Therefore, the time-frequency resources consumption will be reduced, and power of the transmitter and the receiver will be saved.

In some embodiments, all the CBs should start from the same symbol. In this way, the UE may successfully decode the TB (i.e., all the CBs) at an early time.

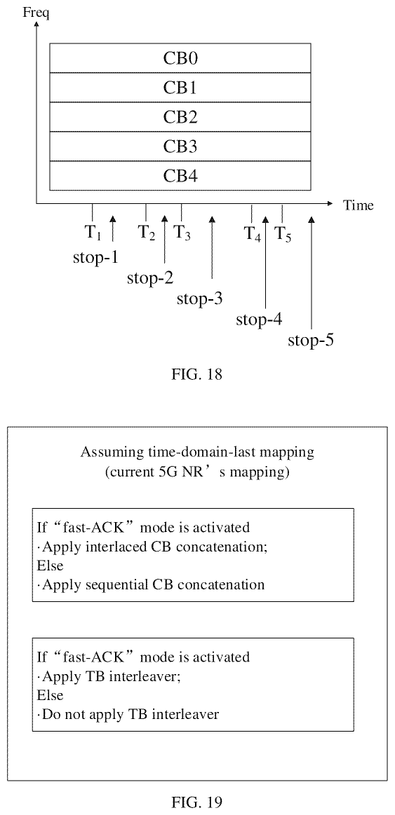

As shown in FIG. 18, the BS starts transmitting CB0-CB4 at the same time. “stop-1,” “stop-2,” “stop-3,” “stop-4,” and “stop-5” are multiple feedback opportunities during transmission of the CBs. Once all the CBs of the TB are decoded successfully, the UE may feed back an ACK immediately at the corresponding feedback opportunity. For example, CB0 is successfully decoded at T2, CB1 is successfully decoded at T3, CB2 is successfully decoded at T1, CB3 is successfully decoded at T2, and CB4 is successfully decoded at T1. In such case, T3 is the latest time at which the five CBs is successfully decoded. In other words, the TB is successfully decoded at T3. Therefore, the UE may feed back an ACK at “stop-3” which is the feedback opportunity immediate after T3. Compared to the other cases where all the CBs are not transmitted at the same time, the UE may successfully decode the TB (i.e., all the CBs) at an earlier time.

In some embodiments, at least two sub-blocks of two different CBs occupy a same time resource. In an example shown in FIG. 18. CB0, CB1, CB2, CB3 and CB4 are mapped to the same time resource. In such case, transmission of the CBs is aligned on time domain and the UE will decode the CBs at the same time (e.g., on a same symbol).

In an implementation, at least two sub-blocks of two different CBs occupy an equal number of frequency resources. The frequency resources may be subcarriers. For example, each sub-blocks contains the same number of bits, and each sub-blocks occupies a same time resource. In such case, each sub-blocks occupies the equal number of subcarriers. For another example, the number of frequency resources occupied by each CB is pre-configured.

Again, referring to FIG. 17, for example, each of sub-blocks CB00, CB10, and CB20 has 336 bits, and each of sub-blocks CB00, CB10, and CB20 occupies 14 symbols. In such case, each sub-blocks occupies 12 subcarriers.

In some embodiments, after subblock segmentation and interleaving, we can take turns to assign the subblocks of each CB to the time-frequency resource plane.

The present disclosure provides another method for data transmission involving conditional mode selection.

For backward compatibility, it needs a mechanism to switch between legacy resource mapping and the proposed mapping. The legacy resource mapping refers to the scheme does not support “fast-ACK,” and the proposed mapping refers to the scheme supports “fast-ACK.” In other words, it needs a mechanism to switch between the present disclosure and the conventional solutions.

In some embodiments, the BS obtains an indication, and the indication indicates whether the method for data transmission supporting “fast-ACK” mode is adopted or a conventional mode (e.g., hybrid automatic repeat request (HARQ) mode) is adopted. In this way, flexible switching between the “fast-ACK” mode and the conventional mode will be enabled.

The switching can be simply realized by an “if-else” pseudocode. There are two possible descriptions, depending on the default resource mapping method.

In one implementation, as shown in FIG. 19, the default setting is the conventional mode which does not support “fast-ACK” (for example, the default is 5G's mapping, i.e., time-domain-last mapping). In such case, if “fast-ACK” mode is activated, interleaved CB concatenation will be applied so that the sub-blocks will be interleaved; if “fast-ACK” mode is not activated, sequential CB concatenation will be applied so that the sub-blocks will not be interleaved.

Alternatively, in the case where the default setting is the conventional mode, if “fast-ACK” mode is activated, TB interleaver will be applied so that the sub-blocks will be interleaved; if “fast-ACK” mode is not activated, sequential CB concatenation will be applied so that the sub-blocks will not be interleaved.

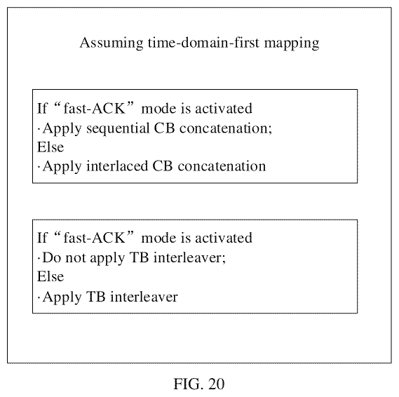

In another implementation, as shown in FIG. 20, the default setting is the proposed mode which supports “fast-ACK.” For example, default is time-domain-first mapping. In such case, if “fast-ACK” mode is activated, sequential CB concatenation will be applied because the sub-blocks of a CB have already been mapped to a relative large amount of time resources so that transmission of a CB will be spread on the time domain. On the other hand, if “fast-ACK” mode is inactivated (i.e., deactivated), interleaved CB concatenation will be applied so that the CB will be mapped to a relative small amount of time resources so that transmission of a CB will not be spread on the time domain.

In another implementation, the default setting is the proposed mode which supports “fast-ACK.” For example, default is time-domain-first mapping. In such case, if “fast-ACK” mode is activated, TB interleaver will not be applied because the sub-blocks of a CB have already been mapped to a relative large amount of time resources so that transmission of a CB will be spread on the time domain. On the other hand, if “fast-ACK” mode is inactivated, TB interleaver will be applied so that the CB will be mapped to a relative small amount of time resources so that transmission of a CB will not be spread on the time domain.

In some embodiments, the BS may indicate the UE to switch between HARQ mode and “fast-ACK” mode via a field in RRC or DCI signaling.

In this way, the proposed mode may co-exist with the legacy mode (e.g., HARQ mode).

This patent discloses the detailed protocol design for codeword interleaving and resource mapping such that a code block is spread on the time domain. The novelties are: new CB concatenation, new TB interleaver, conditional mode selection, and time-domain CB alignment.

New CB concatenation and TB interleaver provide ways of interleaving the CBs with low description complexity so that the subblocks of a CB may spread along the time domain. Therefore, the fast-ACK mode will be enabled. The conditional mode selection is backward compatible and may co-exist with legacy mode. The time-domain CB alignment increase the possibility of early stop.

Some embodiments of the present disclosure provide a computer-readable storage medium (e.g., a non-transitory computer-readable storage medium). The computer-readable storage medium has stored thereon program instructions that, when run on a network device/terminal device, cause the network device/terminal device to execute one or more steps of the method for beam management as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes program instructions carried on a non-transitory computer-readable storage medium. When executed on a network device/terminal device, the computer program instructions cause the network device/terminal device to perform one or more steps of the method for data transmission as described in the above embodiments.

Beneficial effects of the computer-readable storage medium and the computer program product are the same as the beneficial effects of the method for data transmission as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

In some aspects of the present disclosure, there is provided a computer program comprising instructions. The instructions, when executed by a processor, may cause the processor to implement a method of the present disclosure.

In some aspects of the present disclosure, there is provided an integrated circuit. The integrated circuit includes one or more logic circuits for executing the steps of the method for data transmission of the present disclosure.

In some aspects of the present disclosure, there is provided an apparatus comprising means (e.g., at least one processor) to implement a method of the present disclosure. The apparatus may be device (that is, a terminal device or a network device) or a module or component in the device. The at least one processor may execute instructions stored in a computer-readable medium to implement the method.

The apparatus may be a communication device or an apparatus implemented in a communication device. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components.

The solutions described in the disclosure is applicable to a next generation (e.g. sixth generation (6G) or later) network, or a legacy (e.g. 5G, 4G, 3G or 2G) network. The proposed method applies to a wide range of communication networks, such as 5G+, 6G, WiFi, NTN and distributed or self-organized networks.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

The terms “apparatus” and “device” are used exchangeable.

In the disclosure, the word “a” or “an” when used in conjunction with the term “comprising” or “including” in the claims and/or the specification may mean “one,” but it is also consistent with the meaning of “one or more,” “at least one,” and “one or more than one” unless the content clearly dictates otherwise. Similarly, the word “another” may mean at least a second or more unless the content clearly dictates otherwise.

In the disclosure, the words “first,” “second,” etc., when used before a same term (e.g., UE, or an operating step) does not mean an order or a sequence of the term. For example, the “first UE” and the “second UE” means two different UEs without specially indicated, and similarly, the “first step” and the “second step” means two different operating steps without specially indicated, but does not mean the first step have to happen before the second step. The real order depends on the logic of the two steps.

The terms “coupled,” “coupling,” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B,” as used herein, is interchangeable with the expression “A and/or B.” It refers to a list in which you may select A or B or both A and B. Similarly, “at least one of A, B, or C,” as used herein, is interchangeable with “A and/or B and/or C” or “A, B, and/or C.” It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The terms “receive,” “detect,” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “Paging is not received” means the receiving side tries to detect and/or decoding the paging, but does not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive,” “detect,” and “decode” may indicate different procedure at receiving side to obtain the information. Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

1. A method for data transmission, comprising:
mapping one or more sub-code blocks of one or more first codewords to one or more time and frequency resources, wherein the one or more sub-code blocks are interleaved; and
sending one or more second codewords, wherein the one or more second codewords include at least one sub-code block of the one or more sub-code blocks.

2. The method of claim 1, wherein the one or more sub-code blocks correspond to one or more feedback opportunities, and wherein a feedback corresponding to at least one feedback opportunity of the one or more feedback opportunities indicates a decoding result of the one or more first codewords.

3. The method of claim 1, wherein initial sub-blocks of at least two different first codewords of the one or more first codewords are mapped to a same time resource.

4. The method of claim 1, wherein at least two sub-blocks of two different first codewords of the one or more first codewords are mapped to a same time resource.

5. The method of claim 1, wherein at least two sub-blocks of two different first codewords of the one or more first codewords are mapped to an equal number of frequency resources.

6. A method for data transmission, comprising:
receiving one or more second codewords, wherein the one or more second codewords include at least one sub-code block of one or more sub-code blocks of one or more first codewords, and the one or more sub-code blocks of the one or more first codewords are interleaved and mapped to one or more time and frequency resources; and
decoding the one or more second codewords.

7. The method of claim 6, wherein the one or more sub-code blocks correspond to one or more feedback opportunities, wherein a feedback corresponding to at least one feedback opportunity of the one or more feedback opportunities indicates a decoding result of the one or more first codewords.

8. The method of claim 6, wherein initial sub-blocks of at least two different first codewords of the one or more first codewords are mapped to a same time resource.

9. The method of claim 6, wherein at least two sub-blocks of two different first codewords of the one or more first codewords are mapped to a same time resource.

10. The method of claim 6, wherein at least two sub-blocks of two different first codewords of the one or more first codewords are mapped to an equal number of frequency resources.

11. An apparatus for data transmission, comprising:
at least one processor; and
at least one memory coupled to the at least one processor, the at least one memory storing at least part of instructions that, when executed by the at least one processor, causes the apparatus to:
map one or more sub-code blocks of one or more first codewords to one or more time and frequency resources, wherein the one or more sub-code blocks are interleaved; and
send one or more second codewords, wherein the one or more second codewords include at least one sub-code block of the one or more sub-code blocks.

12. The apparatus of claim 11, wherein the one or more sub-code blocks correspond to one or more feedback opportunities, and wherein a feedback corresponding to at least one feedback opportunity of the one or more feedback opportunities indicates a decoding result of the one or more first codewords.

13. The apparatus of claim 11, wherein initial sub-blocks of at least two different first codewords of the one or more first codewords are mapped to a same time resource.

14. The apparatus of claim 11, wherein at least two sub-blocks of two different first codewords of the one or more first codewords are mapped to a same time resource.

15. The apparatus of claim 11, wherein at least two sub-blocks of two different first codewords of the one or more first codewords are mapped to an equal number of frequency resources.

16. An apparatus for data transmission, comprising:
at least one processor; and
at least one memory coupled to the at least one processor, the at least one memory storing at least part of instructions that, when executed by the at least one processor, causes the apparatus to:
receive one or more second codewords, wherein the one or more second codewords include at least one sub-code block of one or more sub-code blocks of one or more first codewords, and the one or more sub-code blocks of the one or more first codewords are interleaved and mapped to one or more time and frequency resources; and
decode the one or more second codewords.

17. The apparatus of claim 16, wherein the one or more sub-code blocks correspond to one or more feedback opportunities, wherein a feedback corresponding to at least one feedback opportunity of the one or more feedback opportunities indicates a decoding result of the one or more first codewords.

18. The apparatus of claim 16, wherein initial sub-blocks of at least two different first codewords of the one or more first codewords are mapped to a same time resource.

19. The apparatus of claim 16, wherein at least two sub-blocks of two different first codewords of the one or more first codewords are mapped to a same time resource.

20. The apparatus of claim 16, wherein at least two sub-blocks of two different first codewords of the one or more first codewords are mapped to an equal number of frequency resources.
